(19) United States
(12) Patent Application Publication
(10) Pub. No.: US 2026/0261798 A1
(43) Pub. Date: Sep. 3, 2026

(54) FLEXIBLE NETWORKING SYSTEM AND METHOD FOR SUPPORTING MULTI-LEVEL CASCADED OMNIDIRECTIONAL SPEAKERPHONE

(71) Applicant: SHEN ZHEN PROITAV TECHNOLOGY CO. LTD., Baoan Dist, Shenzhen, Guangdong (CN)

(72) Inventors: Hao TAN, Baoan Dist, Shenzhen, Guangdong (CN); Junjie XIE, Baoan Dist, Shenzhen, Guangdong (CN); Jia CAO, Baoan Dist, Shenzhen, Guangdong (CN); Yi XIAO, Baoan Dist, Shenzhen, Guangdong (CN); Duoling XIAO, Baoan Dist, Shenzhen, Guangdong (CN)

(21) Appl. No.: 18/726,597

(22) PCT Filed: Nov. 20, 2023
(86) PCT No.: PCT/CN2023/132759

§ 371 Date: Jul. 3, 2024

(30) Foreign Application Priority Data
Dec. 8, 2022 (CN) 202211571847.6

(51) Int. Cl. H04R 3/00

(52) U.S. Cl. CPC H04R 3/005; H04R 3/007; H04R 2420/01; H04R 2420/07; H04R 2499/01

(57) ABSTRACT

A flexible networking system and method for supporting multi-level cascaded omnidirectional speakerphone. The system includes a computer and a device; each device includes an audio processor, a cascaded data interface, an array microphone and a loudspeaker; the cascaded data interface is configured to transmit a sound signal sent by the audio processor to other device, receive audio data transmitted from the other device and send the audio data to the audio processor; the array microphone is configured to collect audio data of an external sound source and transmit the audio data to the audio processor of the device; the loudspeaker is configured to receive and play the audio data from the audio processor.

### CROSS-REFERENCE TO RELATED APPLICATIONS

This application is a 35 U.S.C. § 371 national stage application of PCT patent application No. PCT/CN2023/132759, filed on Nov. 20, 2023, which claims priority to Chinese patent application No. 202211571847.6, filed on Dec. 8, 2022, and entitled “flexible networking system and method for supporting multi-level cascaded omnidirectional speakerphone”, the entire contents each of which is incorporated herein by reference.

### TECHNICAL FIELD

The present application relates to the field of computer and Internet technologies, and more particularly, to a flexible networking system for supporting multi-level cascaded omnidirectional speakerphone, and a flexible networking method for supporting multi-level cascaded omnidirectional speakerphone.

### BACKGROUND

When an omnidirectional speakerphone is deployed in a traditional conference room, since the conference room is relatively large, and a coverage range of the omnidirectional speakerphone is limited, cascading and expanding of multiple omnidirectional speakerphones may be considered, array microphones and loudspeakers of the cascaded omnidirectional speakerphones may be performed simultaneously, synchronization needs to be ensured.

Currently, a commonly used solution is provision of a host machine with a plurality of cascaded slave machines, as shown in FIG. 9. In the entire system, only the host machine can be connected to a computer, other devices are all used as slave machines for transmitting audio data of microphones to the host machine, and the host machine sends audio data of a loudspeaker to the plurality of slave machines at the same time. Such system mainly has the following defects:
First, it is inconvenient to be used by a user, in the conference room, devices are arranged in a distributed manner, when the user wants to use an omnidirectional speakerphone system, the user needs to sit near the host machine to use the omnidirectional speakerphone system;
Second, when the host machine malfunctions, the entire system cannot be used, since the host machine serving as a single point is provided in the system, once the host machine malfunctions, the entire system cannot be used, the system does not have fault tolerance.

In view of this, a Chinese patent application No. CN201320133108.9 discloses an ad hoc network voice transmission system, this system includes a microphone and an acoustic compressor connected to the microphone. The acoustic compressor is connected with a signal transmitter, the signal transmitter is connected with a signal receiver through a wireless ad hoc network, the signal receiver is connected with a demodulator, the demodulator is connected with a loudspeaker, the wireless ad hoc network is a distributed wireless network which is expandable by cascading. Although the patent application implements voice transmission, the patent application mainly solves the problem of complex outdoor environment and adopts a wireless private frequency mainly, a solution of a cluster of wireless interphones is adopted. Although multiple interphones are allowed to communicate simultaneously in this solution, the multiple interphones can only perform networking by themselves, and cannot be communicated with an external device.

Another Chinese patent application No. CN202023230501.9 discloses a conference sound box and a conference system. The conference sound box includes a Wi-Fi module, an audio input module, a system chip, and a power amplifier module. The system chip is respectively connected to the Wi-Fi module, the audio input module, and the power amplifier module. The Wi-Fi module is further configured to connect to other conference sound box(s) to perform a bidirectional communication with said other conference sound box(s). Where, networking is realized by connecting the Wi-Fi module with one or multiple other conference sound boxes. Thus, not only the audio of the audio input module can be sent to other conference sound boxes, the audio sent by said another conference sound box can also be obtained and then played through the power amplification module. Cascading of conference sound boxes is realized, a sound pickup distance of the conference sound boxes is increased, and the conference sound boxes can also have a good usage effect in a larger conference room. Networking through Wi-Fi mode is used in this patent, and this networking through Wi-Fi mode is a broadcast mode, that is, a master device is directly connected to all host machines, and the master device is fixed instead of being replaceable in a plug-and-play mode, manual reconfiguration of the user is required. The defect of the manual reconfiguration is that the user must be close to the master device, once the host machine malfunctions, reconfiguration is needed and a configuration process is tedious and complex, and a preemption capability is not provided.

As described above, the related art needs to be further improved.

### SUMMARY

Aiming at the technical problems existing in the background, the present application provides a flexible networking system and a networking method for supporting multi-level cascaded omnidirectional speakerphone with a low fault rate and a high transmission efficiency, in the flexible networking system and the flexible networking method, any level cascaded omnidirectional speakerphone can be implemented as an audio source (host) device connected to a computer, and thus a user can use the omnidirectional speakerphone more flexibly in the conference room.

In order to solve the technical problems mentioned above, a flexible networking system for supporting multi-level cascaded omnidirectional speakerphone is provided in the present application. The flexible networking system includes: a computer and at least one device(s) electrically connected to the computer, adjacent devices of the at least one device(s) are electrically connected with each other;
each device includes an audio processor, a cascaded data interface, an array microphone, and a loudspeaker;
when the device serves as a slave device, the audio processor is configured to receive audio data of the array microphone of the device when the device serves as a slave device, receive audio data from a master device and use the audio data received from the master device as a reference signal, process the audio data, send the processed audio data to the cascaded data interface, and send the audio data from the master device to the loudspeaker to be played; when the device serves as the master device, the audio processor is configured to receive the audio data of the array microphone of the device which is served as the master device, receive the audio data from the computer and use the audio data received from the computer as the reference signal, perform energy comparison on the audio data received from the computer and the processed audio data from the cascaded data interface, select a group of audio data having a maximum energy and send this group of audio data to the computer, and send the audio data of the computer to the loudspeaker;
the cascaded data interface is configured to transmit a sound signal sent by the audio processor to other device, and receive audio data transmitted from the other device, and send the audio data transmitted from said another device to the audio processor;
the array microphone is configured to collect audio data from an external sound source and transmit the audio data to the audio processor of the device which the microphone is comprised in;
the loudspeaker is configured to receive and play audio data from the audio processor.

According to the flexible networking system for supporting the multi-level cascaded omnidirectional speakerphone, the cascaded data interface includes an upper level cascaded data interface, and a lower level cascaded data interface;
the upper level cascaded data interface is configured to transmit a sound signal sent by the audio processor to a device at an upper level, and receive audio data transmitted from the device at the upper level, and send the audio data received from the device at the upper level to the audio processor;
the lower level cascaded data interface is configured to transmit the sound signal sent by the audio processor to a device at a lower level, and receive audio data transmitted from the device at the lower level, and send the audio data received from the device at the lower level to the audio processor.

A flexible networking method for supporting multi-level cascaded omnidirectional speakerphone, which is based on the flexible networking system for supporting the multi-level cascaded omnidirectional speakerphone. The method includes a master-slave decision process, an audio source switching control process and an audio data transmission process;
the master-slave decision process includes a device initialization process, a master device adding process, and a master device losing process.

The device initialization process is specifically described as follows: in a default condition, when the upper level cascaded data interface of a device is not connected to other device, the device is automatically initialized to a master device after being powered on, and the device is set as an audio source, and records the audio source; when the upper level cascaded data interface of the device is connected to the other device, the device is automatically initialized to a slave device after being powered on, and the device is set as a non-audio source.

The master device adding process is specifically described as follows: after a device is newly added to the upper level cascaded data interface of the master device, the newly added device is initialized according to an initialization process and broadcasts an initialization message; an original master device receives the broadcasted initialization message and is reinitialized to a slave device used as the non-audio source; the other device receives the broadcasted initialization message, and is/are reinitialized to slave device used as the non-audio source.

The master device losing process is specifically described as follows: after the slave device determines that the master device is lost, the initialization process is started, and the slave device is switched to the master device used as the audio source; the other device receives the broadcasted initialization message and is reinitialized to the slave device used as the non-audio source.

The audio source switching control process includes following steps:
step S1, after the computer is connected to any device, submitting, by the device which the computer is connected to, a request for the audio source to the master device;
step S2, by the master device, recording the audio source and broadcasting a new audio source message, and switching to the non-audio source simultaneously, and changing an audio data transmission direction according to an interface of the new audio source, after receiving the request for the audio source;
step S3, by the other device, performing a processing according to its own state of being the audio source or being the non-audio source after receiving the broadcast message, switching to the non-audio source if it is the audio source, and changing the audio data transmission direction according to the interface of the new audio source;
step S4, performing a preempting operation if a new computer accesses to another device, and submitting the request for the audio source to the master device by the device which the new computer is accessed to;
step S5, by the master device, recording the audio source and broadcasting the new audio source message, and switching to the non-audio source simultaneously, and changing the audio data transmission direction according to the interface of the new audio source, after receiving the request for the audio source;
step S6, by the other device, performing the processing according to its own state of being the audio source or being the non-audio source, and switching to the non-audio source if it is the audio source, and changing the audio data transmission direction according to the interface of the new audio source, after receiving the broadcast message;
step S7, performing a return operation, submitting a request of releasing the audio source to the master device by the device currently serving as the audio source, after the computer which is connected to the device currently serving as the audio source is disconnected;
step S8, by the master device, rerecording the audio source, selecting a previous audio source in a record as a new audio source and broadcasting the new audio source message, and switching to the non-audio source simultaneously, and changing the audio data transmission direction according to the interface of the new audio source, after receiving the request of releasing the audio source;
step S9, by the other device, changing the audio data transmission direction according to the interface of the new audio source after receiving the broadcasted new audio source message;
step S10, after a device which previously serves as the audio source receives the broadcasted new audio source message, switching to the audio source and changing the audio data transmission direction by the device which previously serves as the audio source;

The audio data transmission process is specifically described as follows: the device which serves as the audio source completes an audio processing according to the audio signal obtained from the computer after pickup of an array microphone, and performs an energy comparison on the processed audio data and audio data uploaded from the non-audio source, and selects one group of data having maximum energy, sends this group of data to the computer, and sends an audio signal obtained by the computer to the loudspeaker. A device which serves as the non-audio source completes the audio processing according to the audio signal obtained from a cascaded data interface in an audio source direction after pickup of the array microphone, and performs the energy comparison on the processed audio data and the audio data transmitted from a cascaded data interface in a non-audio source direction, selects one group of data having maximum energy, and sends this group of data to the cascaded data interface in the audio source direction.

According to the flexible networking method for the for supporting multi-level cascaded omnidirectional speakerphone, where the method further includes an abnormity protection process. The abnormity protection process is specifically described as follows: the master device may periodically detect whether the audio source is normal by broadcasting a message; after the other device receives the broadcasted message, the other device changes the audio data transmission direction according to the interface of the new audio source if it is not the new audio source; or alternatively, the other device is switched to the audio source, and changes the audio data transmission direction if it is the new audio source.

According to the flexible networking method for the for supporting multi-level cascaded omnidirectional speakerphone, where the master device periodically detects whether the audio source is normal by broadcasting the message specifically includes: if the master device detects that the audio source is abnormal, the master device records the audio source again, selects a previous audio source in the record as a new audio source, and broadcasts a new audio source message; moreover, the master device is switched to the non-audio source, and changes the audio data transmission direction according to the interface of the new audio source; if the previous audio source is the master device itself, the master device is switched to the audio source and changes the audio data transmission direction.

According to the flexible networking method for the for supporting multi-level cascaded omnidirectional speakerphone, where the device which serves as the audio source receives audio data bidirectionally in the audio data transmission process.

According to the flexible networking method for the for supporting multi-level cascaded omnidirectional speakerphone where the device which serves as the non-audio source further sends the audio signal obtained from the cascaded data interface in the audio source direction to the loudspeaker in the audio data transmission process, after the pickup of the array microphone.

According to the flexible networking method for the for supporting multi-level cascaded omnidirectional speakerphone, where the computer is connected to an interface of any omnidirectional speakerphone in a wired connection manner.

According to the flexible networking method for the for supporting multi-level cascaded omnidirectional speakerphone, where a wireless connection between the computer and any omnidirectional speakerphone is established.

According to the flexible networking method for the for supporting multi-level cascaded omnidirectional speakerphone, where any one of a Mesh sharing manner and a specified working manner is adopted for the wireless connection between the computer and the omnidirectional speakerphone.

By applying the aforesaid technical solutions, the present application has the following beneficial effects:

The flexible networking system and method for supporting the multi-level cascaded omnidirectional speakerphone according to the present application has a reasonable concept, any level cascaded omnidirectional speakerphone can be used as the audio source (host) device connected to the computer, thus, the user can use this device more flexibly in the conference room. Moreover, since any level cascaded omnidirectional speakerphone can be used as the audio source, due to this reason, in the networking process of the whole system, all devices may be backed up, a single-point fault would not occur. When one of these devices malfunctions, networking may be realized again only by re-connecting cascaded wires. As an alternative, when changing of usage environment of the device is detected, a larger coverage area may be realized only by adding more devices without complete re-deployment. After multiple devices are cascaded, the entire networking or initialization process is automatically completed without the need of user operation or setting, plug-and-play is provided for the user, which greatly simplifies the complexity of deployment.

### DESCRIPTION OF THE DRAWINGS

In order to explain the technical solutions in the embodiments of the present disclosure or the related art more clearly, a brief introduction regarding the accompanying drawings that need to be used for describing the embodiments or the related art is given below. It is obvious that the accompanying figures described below are some embodiments of the present disclosure. For the person of ordinary skill in the art, other drawings may also be obtained according to these drawings without paying creative effort.

FIG. 1 illustrates a principle diagram of a structural connection of a flexible networking system for supporting multi-level cascaded omnidirectional speakerphone according to the present application;

FIG. 2 illustrates a principle diagram of a structural connection of adjacent devices of the flexible networking system for the for supporting multi-level cascaded omnidirectional speakerphone according to the present application;

FIG. 3 illustrates a flow diagram of device initialization in a flexible networking method for supporting multi-level cascaded omnidirectional speakerphone according to the present application;

FIG. 4 illustrates a flow diagram of adding new device in the flexible networking method for the for supporting multi-level cascaded omnidirectional speakerphone according to the present application;

FIG. 5 illustrates a flow diagram of losing device in the flexible networking method for the for supporting multi-level cascaded omnidirectional speakerphone according to the present application;

FIG. 6 illustrates a flow diagram of switching control of an audio source in the flexible networking method for the for supporting multi-level cascaded omnidirectional speakerphone according to the present application;

FIG. 7 illustrates a flow diagram of abnormity protection in the flexible networking method for the for supporting multi-level cascaded omnidirectional speakerphone according to the present application;

FIG. 8 illustrates a flow diagram of audio data in the flexible networking method for the for supporting multi-level cascaded omnidirectional speakerphone according to the present application; and

FIG. 9 illustrates a principle diagram of a structural connection of a current system for mainstream networking according to the present application.

### DETAILED DESCRIPTION OF EMBODIMENTS

The technical solutions of the present application will be described clearly and comprehensively below with reference to the accompanying drawings. It is apparent that, the embodiments described below are only some embodiments of the present application, rather than all embodiments. Based on the embodiments in the present application, other embodiments which are obtained by a person of ordinary skill in the art without paying creative labor, should all be included in the protection scope of the present application.

The present application is explained and illustrated with reference to the detailed description of embodiments below:

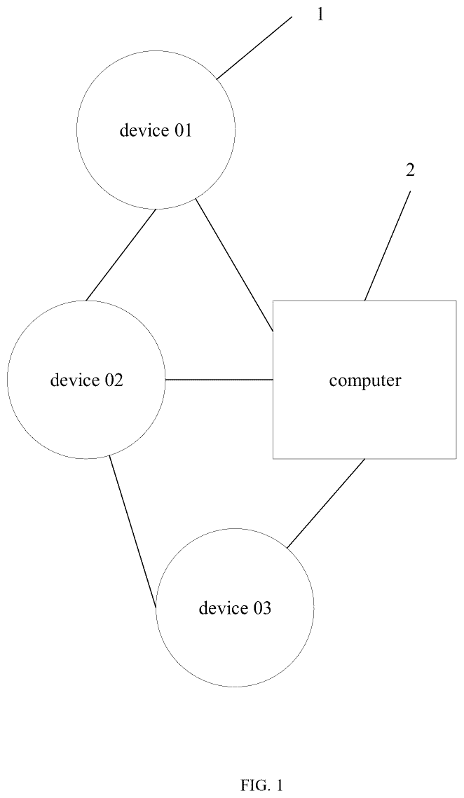

As shown in FIG. 1, the flexible networking system for the for supporting multi-level cascaded omnidirectional speakerphone provided in this embodiment includes a computer 1 and at least one (one or more) device(s) 2 electrically connected to the computer 1, and adjacent devices 2 are electrically connected with each other.

In FIG. 1, the devices 2 include three devices, that is, a device 01, a device 02, and a device 03, any one of the device 01, the device 02 and the device 03 may be connected to the computer 1. Any one of the devices 2 in the system may be used as an audio source (a device connected to the computer 1 is defined as an audio source, which is equivalent to a host machine in the conventional solution) or used independently.

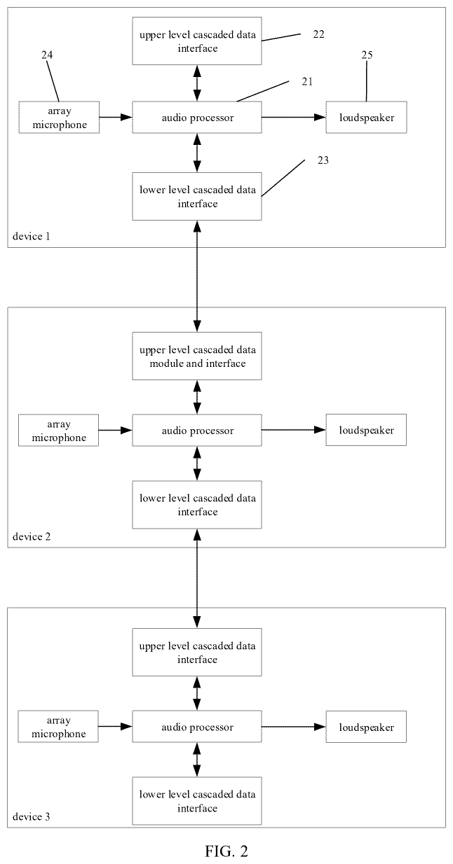

As shown in FIG. 2, each device 2 includes an audio processor 21, an upper level cascaded data interface 22, a lower level cascaded data interface 23, an array microphone 24, and a loudspeaker 25. The upper level cascaded data interface 22 and the lower level cascaded data interface 23 are constituted as cascaded data interface.

When the device 2 is served as a slave device, the audio processor 21 is configured to receive audio data of the array microphone 24 of the device 2 used as the slave device, receive audio data from a master device (which is transmitted by the upper level cascaded data interface 2, the lower level cascaded data interface 23) and take the audio data as a reference signal, in order to complete functions including echo cancellation, noise suppression, send the processed audio data to the upper level cascaded data interface 22 (in a upper direction of the master device) or the lower level cascaded data interface 23 (in a lower direction of the master device), and send the audio data from the master device to the loudspeaker 25 to be played. When the device 2 is served as the master device, the audio data of the array microphone 24 of the device 2 used as the master device is received, the audio data from the computer is received as a reference signal, energy comparison is performed on the audio data from the computer and the audio data from the upper level cascaded data interface 22, the lower level cascaded data interface 23, the group of audio data with the maximum energy is selected and is sent to the computer 1, and the audio data of the computer 1 is sent to the loudspeaker 25.

The upper level cascaded data interface 22 is configured to transmit the sound signal sent by the audio processor 21 to a device 2 at an upper level, and receive the audio data transmitted from the upper level device 2 simultaneously, and send the audio data to the audio processor 21.

The lower level cascaded data interface 23 is configured to transmit the sound signal sent by the audio processor 21 to a device 2 at a lower level, and receive the audio data transmitted from the device 2 at the lower level simultaneously, and send the audio data to the audio processor 21.

The array microphone 24 is configured to collect audio data of an external sound source, and transmit the audio data to the audio processor 21 of the device 2 where the microphone 24 is included.

The loudspeaker 25 is configured to receive and play audio data from the audio processor 21.

The flexible networking method for supporting the multi-level cascaded omnidirectional speakerphone according to the present application is mainly divided into a master-slave decision process, an audio source switching control process, an abnormity protection process and an audio data transmission process.

The master-slave decision process mainly includes a device initialization process, a newly added master device process, and a lost master device process.

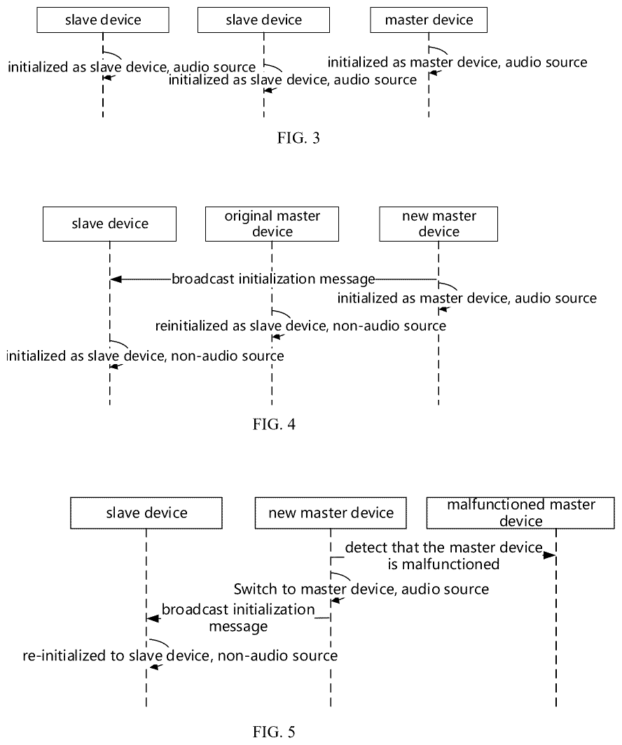

As shown in FIG. 3, the device initialization process is specifically described as follows: in a default condition, when the upper level cascaded data interface 22 of the device 2 is not connected with other device, the device 2 is automatically initialized to the master device after being powered on, and the device 2 is set as an audio source and records the audio source. When the upper level cascaded data interface 22 of the device 2 is connected with other device, the device 2 is automatically initialized to a slave device after being powered on, and is set as a non-audio source.

The aforesaid master device adding process refers to that in the original existing networking solution, after a new device 2 is added to the uppermost stage of the system, the newly added device 2 will reinitialize the whole system since it is located at the most front end of the whole system. The newly added device 2 will become the master device of the system, and the original master device of the system will automatically become the slave device.

As shown in FIG. 4, the master device adding process specifically includes: after a device is added to the upper level cascaded data interface 22 of the master device, the new device will be initialized according to the initialization process and broadcasts an initialization message. When the original master device receives the broadcasted initialization message, the original master device is reinitialized as a slave device that serves as a non-audio source. The other device receives the broadcasted initialization message, and is reinitialized as a slave device that serves as a non-audio source.

The aforesaid master device losing process refers to failure of the original master device in the system, the entire system is re-initialized, and one device in the system is switched from an original slave device to a new master device, so as to manage the entire system.

As shown in FIG. 5, the master device losing process specifically includes: after the slave device detects that the master device is lost, the slave device start the initialization process so as to be switched to the master device serving as the audio source; the other device receives the broadcasted initialization message and is reinitialized to the slave device serving as the non-audio source.

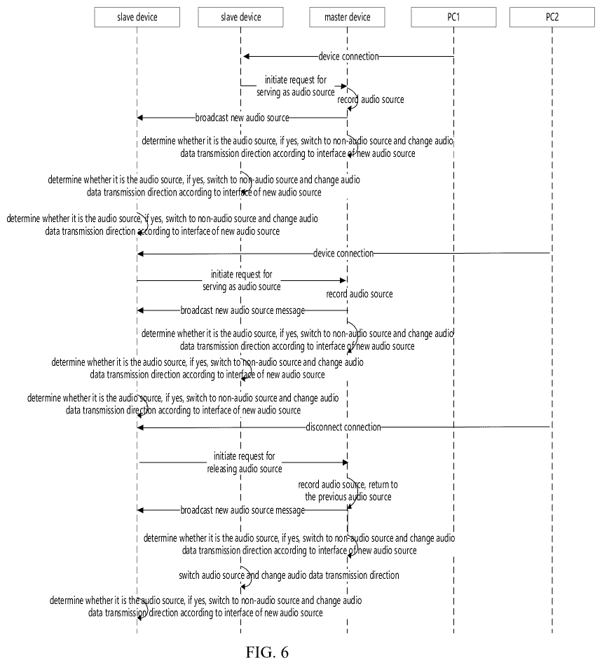

As shown in FIG. 6, the aforesaid audio source switching control process mainly includes the following steps:
at a step S1, after the computer 1 is connected to any device 2, the device 2 submits a request for an audio source to the master device;
at a step S2, after receiving the request for the audio source, the master device records the audio source and broadcasts a new audio source message, and is switched to the non-audio source simultaneously; moreover, the master device changes an audio data transmission direction according to an interface of the new audio source;
at a step S3, after receiving the broadcast message, the other device performs a processing according to its own state of being the audio source or being the non-audio source. The other device is switched to the non-audio source if it is the audio source; moreover, the other device changes the audio data transmission direction according to the interface of the new audio source;
at a step S4, if a new computer 1 accesses to another device 2, a preempting operation is performed, the device 2 will submit the request for the audio source to the master device;
at a step S5, after receiving the request for the audio source, the master device records the audio source and broadcasts the new audio source message, and is switched to the non-audio source simultaneously; moreover, the master device changes the audio data transmission direction according to the interface of the new audio source;
at a step S6, after receiving the broadcast message, the other device performs a processing according to its own state of being the audio source or being the non-audio source, switches to the non-audio source if it is the audio source, and changes the audio data transmission direction according to the interface of the new audio source;
at a step S7, after the computer 1 which is connected to the current device 2 is disconnected, a return operation is performed, the device 2 submits a request of releasing the audio source to the master device;
at a step S8, after receiving the request of releasing the audio source, the master device rerecords the audio source, selects a previous audio source in a record as a new audio source and broadcasts the new audio source message, and is switched to the non-audio source simultaneously; moreover, the master device changes the audio data transmission direction according to the interface of the new audio source;
at a step S9, after receiving the broadcasted new audio source message, the other device changes the audio data transmission direction according to the interface of the new audio source;
at a step S10, a device 2 which previously serves as the audio source receives the broadcasted new audio source message, and then is switched to the audio source, and changes the audio data transmission direction. Only one device 2 is served as the audio source at the same time in the entire system, the audio source is generally connected to a PC; if two devices 2 are connected to the PC successively, then, the device 2 which is connected to the PC later will notify the master device and is served as the audio source; the master device in the system will broadcast a message; however, the device 2 which is previously used as the audio source will release the audio source and becomes a standard slave device after receiving the broadcast message.

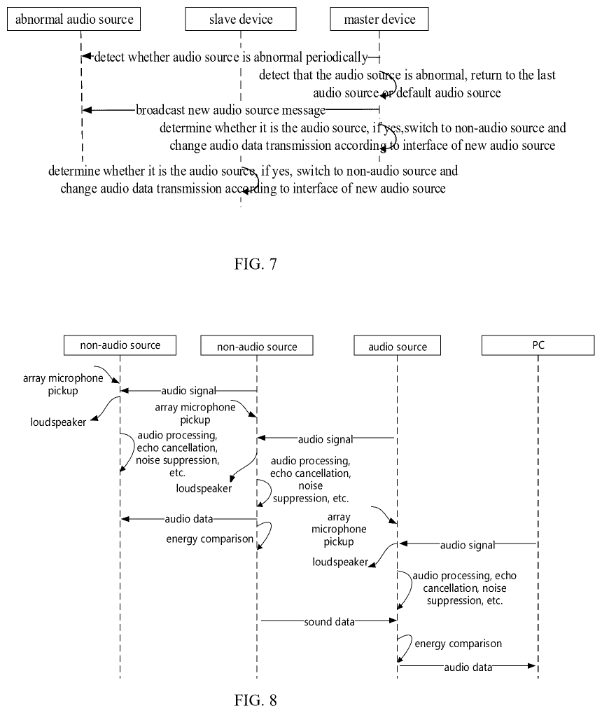

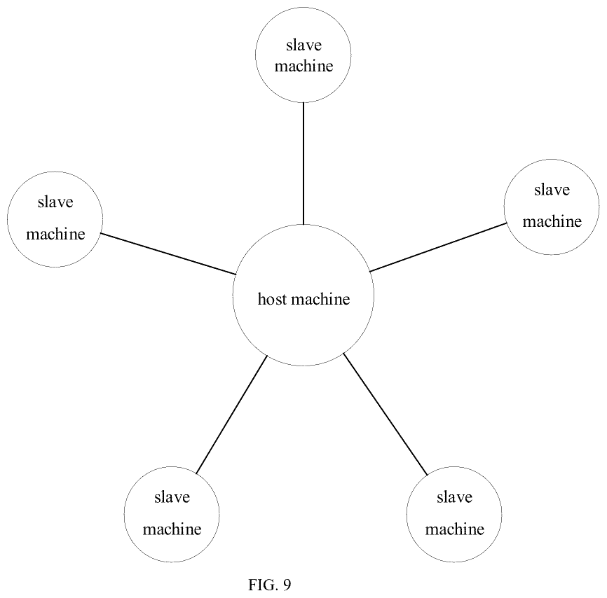

As shown in FIG. 7, the aforesaid abnormality protection process is specifically as follows: the master device periodically detects whether the audio source is normal by broadcasting a message; if it is detected that the audio source is abnormal, the audio source will be re-recorded, and the previous audio source in the record is selected as the new audio source, and the new audio source message is broadcasted. Moreover, the master device is switched to the non-audio source and changes the audio data transmission direction according to the interface of the new audio source. If the previous audio source is the master device itself, the master device is switched to the audio source and changes the audio data transmission direction. After receiving the broadcast message, the other device switches the audio data transmission direction according to the interface of the new audio source if it is not the new audio source; or alternatively, the other device is switched to the audio source and changes the audio data transmission direction if it is the new audio source.

As shown in FIG. 8, the audio data transmission process is specifically described as follows: the device 2 which serves as the audio source completes audio processing according to the audio signal obtained from the computer 1 after pickup of an array microphone 24, and performs an energy comparison (the device 2 serving as the audio source may receive audio data in two directions) on the processed audio data and audio data uploaded from the non-audio source, and selects one group of data having maximum energy, sends the data to the computer 1, and sends an audio signal obtained by the computer 1 to the loudspeaker 25. A device 2 which serves as the non-audio source completes the audio processing according to the audio signal obtained from a cascaded data interface in an audio source direction after pickup of the array microphone 24, and performs the energy comparison on the processed audio data and the audio data transmitted from a cascaded data interface in a non-audio source direction, selects one group of data having maximum energy, and sends the selected data to the cascaded data interface in the audio source direction, and sends the audio signal obtained from the cascaded data interface in the audio source direction to the loudspeaker 25.

In addition, a connection between the interface of the computer 1 and the interface of any omnidirectional speakerphone may be a wired connection (e.g., via USB or network cable). The connection may also be a wireless connection (e.g., via Wi-Fi or Bluetooth). The implementation of the connection manner is not limited. Regarding the wireless connection, the wireless connection may be a Mesh sharing manner (i.e., the computer 1 automatically connects to a device having the strongest signal intensity), and may also be a specified working manner (i.e., only one omnidirectional speakerphone provides a wireless connection interface, and this omnidirectional speakerphone may be specified as the master device, or as the device 2 of the audio source, or the like according to a preset policy).

Any level cascaded omnidirectional speakerphone according to the present application can be used as an audio source (master) device connected to the computer. A user can use the device more flexibly in the conference room, a low failure rate and a high transmission efficiency are realized.

Last, it should be noted that, the various embodiments mentioned above are only intended to explain the technical solutions of the present application, rather than limiting the technical solutions of the present application. Although the present application has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions of the embodiments of the present application.

1. A flexible networking system for supporting multi-level cascaded omnidirectional speakerphone, comprising a computer and at least one device(s) electrically connected to the computer, adjacent devices of the at least one device(s) are electrically connected with each other;
wherein each device comprises an audio processor, a cascaded data interface, an array microphone, and a loudspeaker;
when the device serves as a slave device, the audio processor is configured to receive audio data of the array microphone of the device when the device serves as the slave device, receive audio data from a master device and use the audio data received from the master device as a reference signal, process the audio data, send the processed audio data to the cascaded data interface, and send the audio data received from the master device to the loudspeaker to be played; when the device serves as the master device, the audio processor is configured to receive the audio data of the array microphone of the device which is served as the master device, receive the audio data from the computer and use the audio data received from the computer as the reference signal, perform energy comparison on the audio data received from the computer and the processed audio data from the cascaded data interface, select a group of audio data having a maximum energy and send the selected group of audio data to the computer, and send the audio data received from the computer to the loudspeaker;
the cascaded data interface is configured to transmit a sound signal sent by the audio processor to other device, and receive audio data transmitted from the other device, and send the audio data transmitted from the other device to the audio processor;
the array microphone is configured to collect audio data from an external sound source and transmit the audio data collected from the external sound source to the audio processor of the device which the microphone is comprised in;
the loudspeaker is configured to receive and play audio data from the audio processor.

2. The flexible networking system for supporting the multi-level cascaded omnidirectional speakerphone according to claim 1, wherein the cascaded data interface comprises an upper level cascaded data interface, and a lower level cascaded data interface;
the upper level cascaded data interface is configured to transmit a sound signal sent by the audio processor to a device at an upper level, and receive audio data transmitted from the device at the upper level, and send the audio data received from the device at the upper level to the audio processor;
the lower level cascaded data interface is configured to transmit the sound signal sent by the audio processor to a device at a lower level, and receive audio data transmitted from the device at the lower level, and send the audio data received from the device at the lower level to the audio processor.

3. A flexible networking method for supporting multi-level cascaded omnidirectional speakerphone, based on the flexible networking system for supporting the multi-level cascaded omnidirectional speakerphone according to claim 1, the method comprising a master-slave decision process, an audio source switching control process and an audio data transmission process;
wherein the master-slave decision process comprises a device initialization process, a master device adding process, and a master device losing process;
the device initialization process is described as follows: in a default condition, when an upper level cascaded data interface of a device is not connected to other device, the device is automatically initialized to a master device after being powered on, is set as an audio source and records the audio source; when the upper level cascaded data interface of the device is connected to the other device, the device is automatically initialized to a slave device after being powered on, and is set as a non-audio source;
the master device adding process is described as follows: after a device is newly added to the upper level cascaded data interface of the master device, the newly added device is initialized according to an initialization process and broadcasts an initialization message; an original master device receives the broadcasted initialization message and is reinitialized to a slave device and serves as the non-audio source; the other device receives the broadcasted initialization message, and is reinitialized to the slave device serving as the non-audio source;
the master device losing process is described as follows: after the slave device determines that the master device is lost, the initialization process is started, and the slave device is switched to the master device serving as the audio source; the other device receives the broadcasted initialization message and is reinitialized to the slave device serving as the non-audio source;
the audio source switching control process comprises following steps:
step S1, after a computer is connected to any device, submitting, by the device which the computer is connected to, a request for the audio source to the master device;
step S2, by the master device, recording the audio source and broadcasting a new audio source message, and switching to the non-audio source simultaneously, and changing an audio data transmission direction according to an interface of a new audio source, after receiving the request for the audio source;
step S3, by the other device, performing a processing according to its own state of being the audio source or being the non-audio source after receiving the new audio source message broadcasted by the master device, switching to the non-audio source if it is the audio source, and changing the audio data transmission direction according to the interface of the new audio source;
step S4, performing a preempting operation if a new computer accesses to another device, and submitting the request for the audio source to the master device by the device which the new computer is accessed to;
step S5, by the master device, recording the audio source and broadcasting the new audio source message, and switching to the non-audio source simultaneously, and changing the audio data transmission direction according to the interface of the new audio source, after receiving the request for the audio source;
step S6, by the other device, performing the processing according to its own state of being the audio source or being the non-audio source, and switching to the non-audio source if it is the audio source, and changing the audio data transmission direction according to the interface of the new audio source, after receiving the new audio source message broadcasted by the master device;
step S7, performing a return operation, submitting a request of releasing the audio source to the master device by the device currently serving as the audio source, after the computer which is connected to the device currently serving as the audio source is disconnected;
step S8, by the master device, rerecording the audio source, selecting a previous audio source in a record as a new audio source and broadcasting the new audio source message, and switching to the non-audio source simultaneously, and changing the audio data transmission direction according to the interface of the new audio source, after receiving the request of releasing the audio source;
step S9, by the other device, changing the audio data transmission direction according to the interface of the new audio source after receiving the broadcasted new audio source message;
step S10, after a device which previously serves as the audio source receives the broadcasted new audio source message, switching to the audio source and changing the audio data transmission direction by the device which previously serves as the audio source;
the audio data transmission process is described as follows: the device which serves as the audio source completes an audio processing according to an audio signal obtained from the computer after pickup of an array microphone, and performs an energy comparison on a processed audio data and audio data uploaded from the non-audio source, and selects one group of data having maximum energy, and sends the selected group of data having maximum energy to the computer, sends an audio signal obtained by the computer to the loudspeaker; a device which serves as the non-audio source completes the audio processing according to the audio signal obtained from a cascaded data interface in an audio source direction after pickup of the array microphone, and performs the energy comparison on the processed audio data and the audio data transmitted from a cascaded data interface in a non-audio source direction, selects one group of data having maximum energy, and sends this group of data to the cascaded data interface in the audio source direction.

4. The flexible networking method for supporting the multi-level cascaded omnidirectional speakerphone according to claim 3, further comprising an abnormity protection process;
the abnormity protection process is described as follows: the master device periodically detects whether the audio source is normal by broadcasting a message; after the other device receives the message broadcasted by the master device, the other device changes the audio data transmission direction according to the interface of the new audio source if it is not the new audio source; or alternatively, the other device is switched to the audio source, and changes the audio data transmission direction if it is the new audio source.

5. The flexible networking method for supporting the multi-level cascaded omnidirectional speakerphone according to claim 4, wherein the master device periodically detects whether the audio source is normal by broadcasting the message specifically comprises: if the master device detects that the audio source is abnormal, the master device records the audio source again, selects a previous audio source in the record as a new audio source, and broadcasts a new audio source message; moreover, the master device is switched to the non-audio source and changes the audio data transmission direction according to the interface of the new audio source simultaneously; if the previous audio source is the master device itself, the master device is switched to the audio source and changes the audio data transmission direction.

6. The flexible networking method for supporting the multi-level cascaded omnidirectional speakerphone according to claim 3, wherein the device which serves as the audio source receives audio data bidirectionally in the audio data transmission process.

7. The flexible networking method for supporting the multi-level cascaded omnidirectional speakerphone according to claim 3, wherein the device which serves as the non-audio source further sends the audio signal obtained from the cascaded data interface in the audio source direction to the loudspeaker after the pickup of the array microphone, in the audio data transmission process.

8. The flexible networking method for supporting the multi-level cascaded omnidirectional speakerphone according to claim 3, wherein the computer is connected to an interface of any omnidirectional speakerphone in a wired connection manner.

9. The flexible networking method for supporting the multi-level cascaded omnidirectional speakerphone according to claim 3, wherein a wireless connection between the computer and any omnidirectional speakerphone is established.

10. The flexible networking method for supporting the multi-level cascaded omnidirectional speakerphone according to claim 9, further comprising: adopting any one of a Mesh sharing manner and a specified working manner is for the wireless connection between the computer and the _omnidirectional speakerphone.

11. A flexible networking method for supporting multi-level cascaded omnidirectional speakerphone, based on the flexible networking system for supporting the multi-level cascaded omnidirectional speakerphone according to claim 2, the method comprising a master-slave decision process, an audio source switching control process and an audio data transmission process;
wherein the master-slave decision process comprises a device initialization process, a master device adding process, and a master device losing process;
the device initialization process is described as follows: in a default condition, when the upper level cascaded data interface of a device is not connected to other device, the device is automatically initialized to a master device after being powered on, is set as an audio source and records the audio source; when the upper level cascaded data interface of the device is connected to the other device, the device is automatically initialized to a slave device after being powered on, and is set as a non-audio source;
the master device adding process is described as follows: after a device is newly added to the upper level cascaded data interface of the master device, the newly added device is initialized according to an initialization process and broadcasts an initialization message; an original master device receives the broadcasted initialization message and is reinitialized to a slave device and serves as the non-audio source; the other device receives the broadcasted initialization message, and is reinitialized to the slave device serving as the non-audio source;
the master device losing process is described as follows: after the slave device determines that the master device is lost, the initialization process is started, and the slave device is switched to the master device serving as the audio source; the other device receives the broadcasted initialization message and is reinitialized to the slave device serving as the non-audio source;
the audio source switching control process comprises following steps:
step S1, after a computer is connected to any device, submitting, by the device which the computer is connected to, a request for the audio source to the master device;
step S2, by the master device, recording the audio source and broadcasting a new audio source message, and switching to the non-audio source simultaneously, and changing an audio data transmission direction according to an interface of a new audio source, after receiving the request for the audio source;
step S3, by the other device, performing a processing according to its own state of being the audio source or being the non-audio source after receiving the new audio source message broadcasted by the master device, switching to the non-audio source if it is the audio source, and changing the audio data transmission direction according to the interface of the new audio source;
step S4, performing a preempting operation if a new computer accesses to another device, and submitting the request for the audio source to the master device by the device which the new computer is accessed to;
step S5, by the master device, recording the audio source and broadcasting the new audio source message, and switching to the non-audio source simultaneously, and changing the audio data transmission direction according to the interface of the new audio source, after receiving the request for the audio source;
step S6, by the other device, performing the processing according to its own state of being the audio source or being the non-audio source, and switching to the non-audio source if it is the audio source, and changing the audio data transmission direction according to the interface of the new audio source, after receiving the new audio source message broadcasted by the master device;
step S7, performing a return operation, submitting a request of releasing the audio source to the master device by the device currently serving as the audio source, after the computer which is connected to the device currently serving as the audio source is disconnected;
step S8, by the master device, rerecording the audio source, selecting a previous audio source in a record as a new audio source and broadcasting the new audio source message, and switching to the non-audio source simultaneously, and changing the audio data transmission direction according to the interface of the new audio source, after receiving the request of releasing the audio source;
step S9, by the other device, changing the audio data transmission direction according to the interface of the new audio source after receiving the broadcasted new audio source message;
step S10, after a device which previously serves as the audio source receives the broadcasted new audio source message, switching to the audio source and changing the audio data transmission direction by the device which previously serves as the audio source;
the audio data transmission process is described as follows: the device which serves as the audio source completes an audio processing according to an audio signal obtained from the computer after pickup of an array microphone, and performs an energy comparison on the processed audio data and audio data uploaded from the non-audio source, and selects one group of data having maximum energy, and sends the selected group of data having maximum energy to the computer, sends an audio signal obtained by the computer to the loudspeaker; a device which serves as the non-audio source completes the audio processing according to the audio signal obtained from a cascaded data interface in an audio source direction after pickup of the array microphone, and performs the energy comparison on the processed audio data and the audio data transmitted from a cascaded data interface in a non-audio source direction, selects one group of data having maximum energy, and sends this group of data to the cascaded data interface in the audio source direction.
